(19) United States
(12) Patent Application Publication
(10) Pub. No.: US 2026/0159033 A1
(43) Pub. Date: Jun. 11, 2026

(54) BIOMETRIC IDENTIFICATION FOR WORK VEHICLES

(71) Applicant: Caterpillar Inc., Peoria, IL (US)

(72) Inventors: Thomas L. TWIGGER, Spalding (GB); Steven GAHLINGS, Great Cambourne (GB)

(73) Assignee: Caterpillar Inc., Peoria, IL (US)

(21) Appl. No.: 18/704,269

(22) PCT Filed: Oct. 4, 2022
(86) PCT No.: PCT/US2022/045634

§ 371 Date: Apr. 24, 2024

(30) Foreign Application Priority Data
Oct. 26, 2021 (GB) 2115395.2

(51) Int. Cl. B60R 25/25; B60R 25/01; G07C 5/00; G07C 5/08; G07C 9/00

(52) U.S. Cl. CPC B60R 25/25; B60R 25/01; G07C 5/006; G07C 5/0816; G07C 9/00563; B60R 2325/308

(57) ABSTRACT

A method of securing a work vehicle. A biometric identifier is collected from an operator using a biometric identification device. The biometric identifier is checked against a list of authorised operators. In an event that the operator matches an authorised operator, access is enabled to the work vehicle and an operator profile is activated that is linked to the authorised operator. During operation of the work vehicle, current machine data for the current session is recorded against the operator profile and targeted information is provided to the operator based on prior machine data for previous sessions. In an event that the operator does not match an authorised operator, access to the work vehicle is prevented.

### FIELD

The disclosure relates to the field of work vehicles.

### BACKGROUND

It is known to use security measures to limit operation of work vehicles to authorised operators. Typically, pin codes or passcodes are used, or Bluetooth keys. These can perform machine security functions to enable use of the machine, or operator ID functions to customize machine settings to the operator. Operator ID can also be used to track performance. Security measures such as pin codes and Bluetooth keys may be shared between operators, lost or forgotten, and so are not guaranteed to be unique to an operator.

Performance of electrical off-highway machines may be tied to the operation characteristics of the operator. In particular, battery life may be affected by the proficiency of the operator. The timing of recharging a given work vehicle and/or servicing of the battery/electric motors, therefore depends on the operator or operators who have been using it, as well as other factors such as the length of time it has been used for and the type of work that has been carried out.

### SUMMARY

Against this background, there is provided a method of securing a work vehicle. The method comprises collecting a biometric identifier from an operator using a biometric identification device. The method further comprises checking the biometric identifier against a list of authorised operators. In an event that the operator matches an authorised operator the method further comprises enabling access to the work vehicle and activating an operator profile linked to the authorised operator. During operation of the work vehicle current machine data for the current session is recorded against the operator profile and targeted information is provided to the operator based on prior machine data for previous sessions. In an event that the operator does not match an authorised operator, the method further comprises preventing access to the work vehicle.

There is also provided a security device for a work vehicle, the security device comprising a biometric identification device. The security device is configured to collect a biometric identifier from an operator using the biometric identification device. The security device is further configured to check the biometric identifier against a list of authorised operators. In the event that the operator matches an authorised operator from the list of authorised operators, the security device is further configured to enable access to the work vehicle and activate an operator profile linked to the authorised operator. During operation of the work vehicle, current machine data for the current session is recorded against the operator profile and targeted information is provided to the user based on prior machine data for previous sessions. In the event that the operator does not match an authorised operator, the security device is further configured to prevent access to the work vehicle.

In this way, the operator can be identified and operation of the work vehicle may be limited to authorised operators. Furthermore, data can be collected that is recorded against an operator profile, which can be used to coach the operator and to monitor the health of the work vehicle.

### BRIEF DESCRIPTION OF THE DRAWINGS

A specific embodiment of the disclosure will now be described, by way of example only, with reference to the accompanying drawings in which:

FIG. 1 shows a flowchart illustrating a method of securing a work vehicle according to an embodiment of the present disclosure.

### DETAILED DESCRIPTION

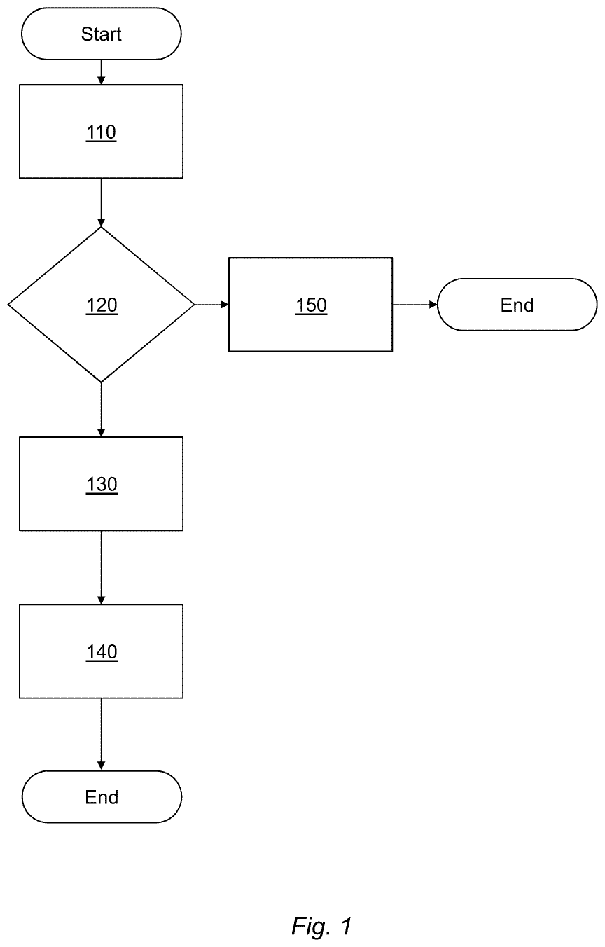

A method of securing a work vehicle according to an embodiment of this disclosure is illustrated in FIG. 1. At step 110 of the method, a biometric identifier is collected from an operator using a biometric identification device. At step 120, the biometric identifier is checked against a list of authorised operators. In the event that the operator matches an authorised operator, access to the work vehicle is enabled at step 130. At step 140, an operator profile is activated that is linked to the authorised operator. During operation of the work vehicle, current machine data for the current session is recorded against the operator profile and targeted information is provided to the user based on prior machine data for previous sessions. The method terminates when the user stops using the work vehicle (for example, if the user logs out, exits the vehicle, or turns the work vehicle off). In the event that, at step 120, the operator does not match an authorised operator, access to the work vehicle is prevented at step 150 and the method terminates.

The work vehicle may comprise a combustion engine, for example a diesel engine, an electric work vehicle, a hydrogen powered work vehicle, or a work vehicle powered by another fuel.

In an embodiment, the biometric identifier may comprise an image of the operator's face, wherein the biometric identification device comprises a facial recognition device. For example, the biometric identification device comprises a camera. The camera may be utilized for other purposes, such as operator fatigue monitoring. In another embodiment, the biometric identifier may comprise a fingerprint of the operator, wherein the biometric identification device comprises a fingerprint reader.

In an embodiment, the biometric identification device may be integrated on the work vehicle, for example at a door to a cab of the work vehicle or in the cab itself. In another embodiment, the biometric identification device may be a smart phone or other device that is configured to wirelessly communicate with the work vehicle. In this embodiment, the step 130 of enabling access to the work vehicle and step 140 of activating the operator profile may comprise sending a wireless signal to the work vehicle. The step 130 of enabling access may be based on proximity, for example between the biometric identification device and the work vehicle.

The current machine data may comprise battery discharge rate. The current machine data may comprise vehicle speed, data relating to tool operations, or other performance metrics related to the work vehicle. The current machine data may comprise information relating to the operator, such as performance metrics or statistics, and battery usage. For example, a payload amount of dirt or other material moved in a given shift.

The current machine data may be used for operator coaching. If the work vehicle or its battery are rented on a subscription basis, the current machine data may be used for setting subscription charges. The current machine data may be used for work vehicle efficiency

The targeted information provided to the operator may be displayed via a monitor on the work vehicle.

The targeted information provided to the operator may be further based on the current machine data. The prior machine data may comprise previous data recorded against the operator profile for previous sessions. For example, the “current machine data” for the same operator from previous sessions using the same or a different work vehicle. The prior machine data may comprise previous data recorded regarding the same work vehicle, used by the same or a different operator.

The targeted information provided to the operator may comprise information relating to how efficiently the work vehicle is being used. This may relate to the work vehicle, for example information relating to the rate of battery discharge. It may relate to operator performance metrics, for example the amount of work they have carried out or the speed at which their work is being completed. The amount of work may comprise a payload quantity of material that has been moved, for example.

The targeted information may comprise predictive information. The predictive information may comprise a predicted remaining battery life (or predicted time before the next charge is required), based on prior machine data and the current state of charge of a battery of the work vehicle. The predicted battery life may be further based on how the operator is using the work vehicle, for example the type of operations performed or the efficiency of use. The prior machine data may comprise data describing battery discharge during similar operating conditions (for example type of machine operations, the identity of the operator) as the work vehicle is currently in.

In an embodiment, the current machine data collected against the operator profile and/or prior machine data recorded against the operator profile may be used for processing the predicted battery life or predicted use of battery charge. The operator profile may be used to predict the battery life or use of battery charge more accurately based on operational characteristics of the operator, wherein the operational characteristics are determined from the prior machine data for previous sessions recorded against the operator profile, when the operator was using the same or a different work vehicle. The operational characteristics may comprise rate of use of battery charge. The predicted battery life or predicted use of battery charge may be based on prior machine data for the same work vehicle and/or prior machine data for the same operator.

The predictive information may comprise a predicted date for the next service of the work vehicle.

The targeted information may comprise coaching messages for improving the operator's performance, such as tips on how to operate the work vehicle more efficiently or in a way that is preferable for battery health. The coaching may be based on prior machine data for the same operator or different operators. For example, the coaching messages may comprise messages informing the operator whether the rate of battery discharge is appropriate or too high, and if the rate of battery discharge is too high the coaching messages may comprise information on how the operator might reduce the rate of battery discharge.

The current machine data recorded against the operator's profile may be used to generate the targeted information in future uses of a work vehicle. The current machine data recorded against the operator's profile may be used to track usage patterns for an operator, for use by an employer or worksite manager.

The operator profile may comprise preferred operator settings associated with the operator profile, such that when the operator profile is activated the settings are loaded. The settings may comprise cab preferences, tool settings, or a preferred operation mode. For example, the settings may comprise settings relating to hydraulic speeds of implements or to other properties of the tools of the work vehicle. The settings may comprise preferred shift speeds or travelling speeds of the work vehicle. The settings may comprise cab preferences such as heating, ventilation, and air conditioning (HVAC) temperature.

Access to the electric work vehicle may be enabled or prevented by one or both of a physical lock and a software interlock. The physical lock may be controlled by a control system of the work vehicle, or wirelessly by the biometric identification device, or in another way. The physical lock or software interlock may allow the cab door to be locked or unlocked. The physical lock or software interlock may allow the work vehicle to be turned on or prevent the work vehicle from being turned on. The work vehicle may enable an operator to turn on some functionality without the physical lock or software interlock, in order to receive the biometric identifier. However, the work vehicle may not be able to move and the tools may not be able to be used without the physical lock or software interlock allowing access.

The list of authorized operators may be controlled remotely, for example via telematics.

According to an embodiment of the present disclosure, there is a security device for a work vehicle. The security device comprises a biometric identification device. The security device is configured to collect a biometric identifier from an operator using the biometric identification device. The biometric identifier is checked against a list of authorised operators. In the event that the operator matches an authorised operator from the list of authorised operators, access to the work vehicle is enabled and an operator profile linked to the authorised operator is activated. During operation of the work vehicle, current machine data for the current session is recorded against the operator profile and targeted information is provided to the user based on prior machine data for previous sessions. In the event that the operator does not match an authorised operator, access to the work vehicle is prevented.

The security device may be on the work vehicle, separate to the work vehicle, or a combination of on the work vehicle and separate to the work vehicle. The security device may comprise a control system of the work vehicle. The security device may comprise a smartphone or other portable device.

The security device may be further configured to carry any of the methods described above.

1. A method of securing a work vehicle, the method comprising:
collecting a biometric identifier from an operator using a biometric identification device;
checking the biometric identifier against a list of authorised operators;
in an event that the operator matches an authorised operator:
enabling access to the work vehicle; and
activating an operator profile linked to the authorised operator, wherein during operation of the work vehicle:
current machine data for the current session is recorded against the operator profile; and
targeted information is provided to the operator based on prior machine data for previous sessions; and
in an event that the operator does not match an authorised operator, preventing access to the work vehicle.

2. The method of claim 1 wherein the biometric identification device comprises one of a facial recognition device and a fingerprint reader.

3. The method of claim 1 wherein the targeted information is further based on the current machine data.

4. The method of claim 1 wherein the work vehicle comprises an electric work vehicle and wherein the current machine data comprises rate of battery discharge.

5. The method of claim 1 wherein the work vehicle comprises an electric work vehicle and wherein the targeted information comprises expected battery life.

6. The method of claim 5 wherein the expected battery life is based on prior machine data comprising battery discharge data recorded against the operator profile for previous sessions.

7. The method of claim 1 wherein the targeted information comprises an expected date of a service of the work vehicle

8. The method of claim 1 wherein the targeted information comprises coaching for improving the operator's performance.

9. The method of claim 1 wherein the security device is further configured to load preferred operator settings associated with the operator profile.

10. The method of claim 1 wherein the biometric identification device is one of:
a smartphone;
an on-board device mounted on the work vehicle.

11. A security device for an work vehicle, the security device comprising a biometric identification device, wherein the security device is configured to:
collect a biometric identifier from an operator using the biometric identification device;
check the biometric identifier against a list of authorised operators;
in the event that the operator matches an authorised operator from the list of authorised operators:
enable access to the work vehicle; and
activate an operator profile linked to the authorised operator, wherein during operation of the work vehicle:
current machine data for the current session is recorded against the operator profile; and
targeted information is provided to the user based on prior machine data for previous sessions; and
in the event that the operator does not match an authorised operator, prevent access to the work vehicle.

12. The security device of claim 11 wherein the biometric identification device comprises one of a facial recognition device and a fingerprint reader.

13. The security device of claim 11 wherein the targeted information is further based on the current machine data.

14. The security device of any of claims 11 wherein the work vehicle comprises an electric work vehicle and wherein the current machine data comprises rate of battery discharge.

15. The security device of any of claims 11 wherein the work vehicle comprises an electric work vehicle and wherein the targeted information comprises expected battery life.
